(19) United States
(12) Patent Application Publication
(10) Pub. No.: US 2021/0251427 A1
(43) Pub. Date: Aug. 19, 2021

(54) Food Storage And Warmer Apparatus

(71) Applicant: Corbin Tyler, Austin, TX (US)

(72) Inventor: Corbin Tyler, Austin, TX (US)

(21) Appl. No.: 16/793,025

(22) Filed: Feb. 18, 2020

(51) Int. Cl. A47J 41/00; A47J 47/14; B65D 81/18; B65D 25/04

(52) U.S. Cl. CPC A47J 41/005; A47J 47/14; B65D 2203/12; B65D 81/18; B65D 25/04; A47J 41/0094

(57) ABSTRACT

A food storage and warmer apparatus for storing food at safe temperatures and heating food for consumption includes a housing defining a housing inside. The housing has an outer wall separated from an inner wall defining a wall cavity. A divider wall is coupled to the housing within the housing inside and defines a plurality of compartments. A lid is coupled to the housing. A heating coil and a battery are coupled within the wall cavity of the bottom side. A control unit is coupled to the housing and is in operational communication with the heating coil and the battery. A temperature probe is coupled to the housing within the wall cavity and extends through the inner wall to the housing inside. The temperature probe is in operational communication with the control unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food storage devices and more particularly pertains to a new food storage device for storing food at safe temperatures and heating food for consumption.

### (2) Description of Related Art Including Information Disclosed Under 37 CFR 1.97 and 1.98

The prior art relates to food storage devices that maintain food temperature. Insulated containers typically maintain food temperature and are not capable of also heating food. Those that are employ complex heating and refrigerating devices to maintain temperatures over long periods of time. What is needed, and what the present invention provides, is an insulated food container to maintain safe, cold temperatures with an integrated heating mechanism to warm the food before consumption.

### BRIEF SUMMARY OF THE INVENTION

An embodiment of the disclosure meets the needs presented above by generally comprising a housing having a front side, a back side, a left side, a right side, a bottom side, and an open top side defining a housing inside. The housing has an outer wall separated from an inner wall defining a wall cavity. A divider wall is coupled to the housing within the housing inside and defines a plurality of compartments. A lid is coupled to the housing. The lid is selectively engageable with the open top side to seal and alternatively expose the housing inside. A heating coil is coupled to the housing within the wall cavity of the bottom side. A battery is coupled to the housing within the wall cavity and is in operational communication with the heating coil. The battery has a charging port extending through the outer wall. A control unit is coupled to the housing front side and is in operational communication with the heating coil and the battery. A temperature probe is coupled to the housing within the wall cavity and extends through the inner wall to the housing inside. The temperature probe is in operational communication with the control unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a food storage and warmer apparatus according to an embodiment of the disclosure.

FIG. 2 is a front elevation view of an embodiment of the disclosure.

FIG. 3 is a rear elevation view of an embodiment of the disclosure.

FIG. 4 is a bottom plan view of an embodiment of the disclosure.

FIG. 5 is a cross-sectional view of an embodiment of the disclosure along line 5-5 of FIG. 2.

### DETAILED DESCRIPTION OF THE INVENTION

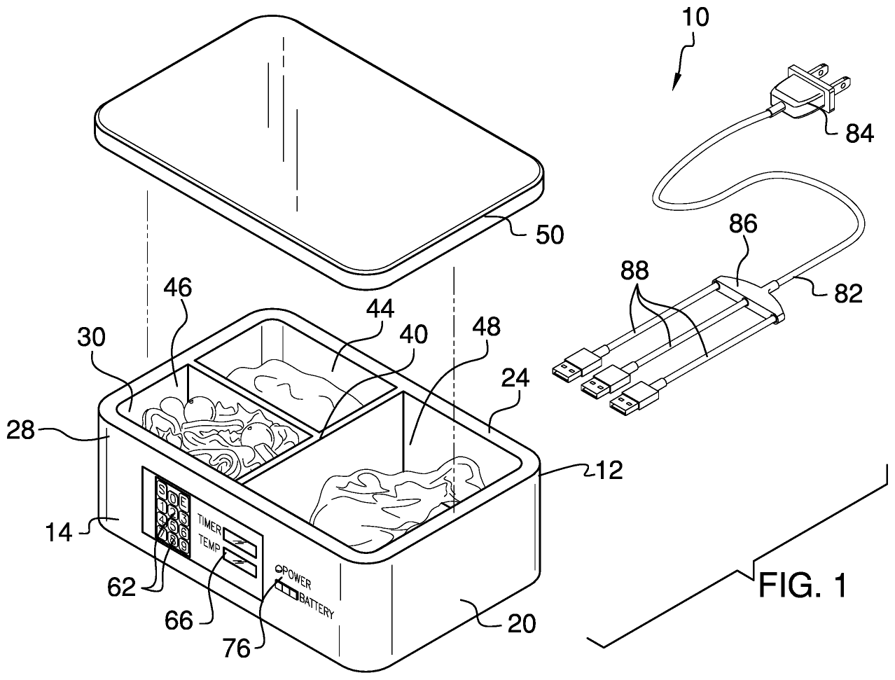

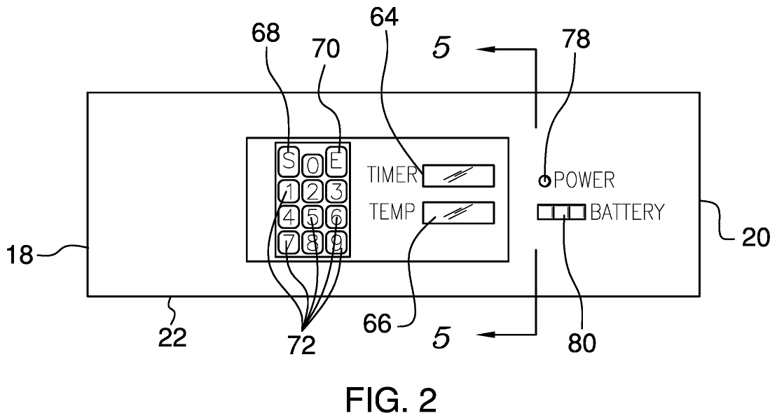

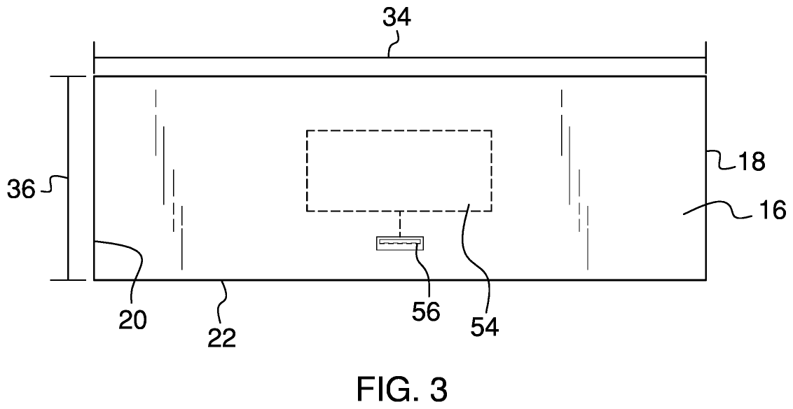

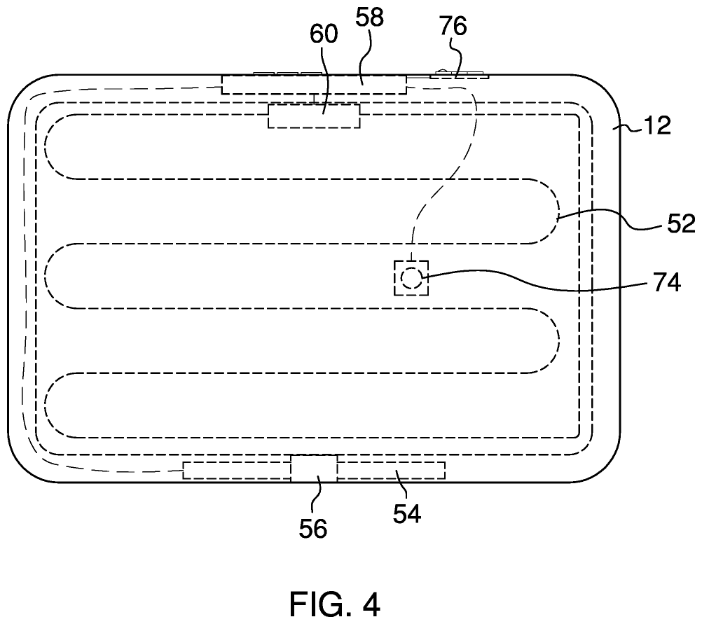

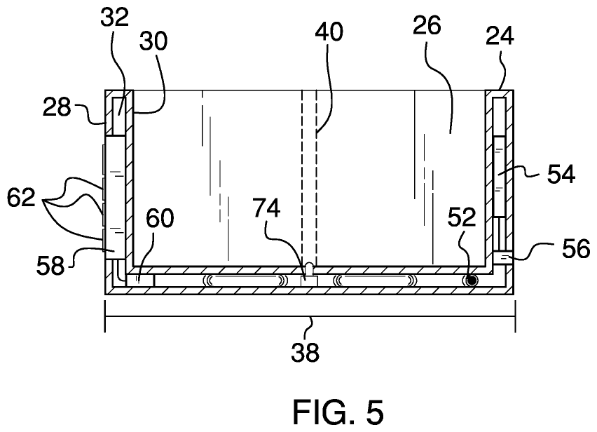

With reference now to the drawings, and in particular to FIGS. 1 through 5 thereof, a new food storage device embodying the principles and concepts of an embodiment of the disclosure and generally designated by the reference numeral 10 will be described.

As best illustrated in FIGS. 1 through 5, the food storage and warmer apparatus 10 generally comprises a housing 12 having a front side 14, a back side 16, a left side 18, a right side 20, a bottom side 22, and an open top side 24 defining a housing inside 26. The housing 12 has an outer wall 28 separated from an inner wall 30 defining a wall cavity 32. The housing 12 may have rounded edges for user comfort and safety while handling. The housing 12 may be kitchen-grade stainless steel or another durable, bacteria and odor resistant, and insulated material. The housing 12 maintains cold food at a safe temperature below 40° Fahrenheit before consumption. A housing length 34 may be equal to three times a housing height 36 and a housing width 38 may be equal to twice the housing height 36.

A divider wall 40 is coupled to the housing bottom side 22 within the housing inside 26. The divider wall 40 defines a plurality of compartments 42 configured to store food without cross-contamination. The divider wall 40 may be T-shaped and the plurality of compartments 42 may comprise a first small compartment 44, a second small compartment 46, and a large compartment 48. The first small compartment 44, the second small compartment 46, and the large compartment 48 may occupy 25%, 25%, and 50% of the housing inside 26, respectively. A lid 50 is coupled to the housing 12. The lid 50 is selectively engageable with the open top side 24 to seal and alternatively expose the housing inside 26. The lid 50 may be the same material as the housing 12.

A heating coil 52 is coupled to the housing 12 within the wall cavity 32 of the bottom side 22. A battery 54 is coupled to the housing 12 within the wall cavity 32 and is in operational communication with the heating coil 52. The battery 54 may be coupled within the back side 16 to avoid overheating from the heating coil 52. The battery 54 has a charging port 56 extending through the outer wall 28.

A control unit 58 is coupled to the front side 14 of the housing and is in operational communication with the heating coil 52 and the battery 54. The control unit 58 may comprise a CPU 60, a plurality of control buttons 62, an integrated timer 64, and a display screen 66. The plurality of control buttons 62 is used to set the timer 64 and the desired temperature of the housing inside 26. The plurality of control buttons 62 may include a start button 68, an end button 70, and a numeric keypad 72.

A temperature probe 74 is coupled to the housing 12 within the wall cavity 32 and extends through the inner wall 30 to the housing inside 26. The temperature probe 74 may be coupled within the bottom side 22. The temperature probe 74 is in operational communication with the control unit 58. The display screen 66 displays the setting of the timer 64 and both the set temperature for the heating coil 58 and the actual temperature within the housing inside 26.

A plurality of indicator lights 76 is coupled to the front side 14 of the housing adjacent the control unit 58. The plurality of indicator lights 76 is in operational communication with the control unit 58 and the battery 54. The plurality of indicator lights 76 includes a power status light 78 and a battery charge level indicator 80.

A multi-unit charging cable 82 has a wall plug 84, a power adaptor splitter 86 in operational communication with the wall plug 84, and a plurality of charge cables 88 in operational communication with the power adaptor splitter 86. The power adaptor splitter 86 may reduce voltage from a 110 or 220 volt outlet to 12 volts. Each charge cable 88 is selectively engageable with the charging port 56. The multi-unit charging cable 82 may thus simultaneously charge multiple food storage and warmer apparatuses 10.

In use, cold food is placed into the plurality of compartments 42. The food may be organized with carbohydrates in the first small compartment 44, vegetables in the second small compartment 46, and protein in the large compartment 48. The lid 50 is engaged and the apparatus 10 is stored and carried until the food is consumed. The control unit 58 is used to set the desired temperature and time for the heating coil 52. Once complete the lid 50 is removed and the food is consumed at a desirable temperature.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food storage and warmer apparatus comprising:
a housing having a front side, a back side, a left side, a right side, a bottom side, and an open top side defining a housing inside, the housing having an outer wall separated from an inner wall defining a wall cavity;
a divider wall coupled to the housing within the housing inside, the divider wall defining a plurality of compartments;
a lid coupled to the housing, the lid being selectively engageable with the open top side to seal and alternatively expose the housing inside;
a heating coil coupled to the housing, the heating coil being coupled within the wall cavity of the bottom side;
a battery coupled to the housing, the battery being coupled within the wall cavity and being in operational communication with the heating coil, the battery having a charging port extending through the outer wall;
a control unit coupled to the housing, the control unit being coupled to the front side of the housing and being in operational communication with the heating coil and the battery; and
a temperature probe coupled to the housing, the temperature probe being coupled within the wall cavity and extending through the inner wall to the housing inside, the temperature probe being in operational communication with the control unit.

2. The food storage and warmer apparatus of claim 1 further comprising the control unit comprising a CPU, a plurality of control buttons, an integrated timer, and a display screen, the plurality of control buttons being used to set the timer and the desired temperature of the housing inside.

3. The food storage and warmer apparatus of claim 1 further comprising a plurality of indicator lights coupled to the front side of the housing, the plurality of indicator lights being in operational communication with the control unit and the battery.

4. The food storage and warmer apparatus of claim 3 further comprising the plurality of indicator lights including a power status light and a battery charge level indicator.

5. The food storage and warmer apparatus of claim 1 further comprising a multi-unit charging cable having a wall plug, a power adaptor splitter in operational communication with the wall plug, and a plurality of charge cables in operational communication with the power adaptor splitter, each charge cable being selectively engageable with the charging port, the multi-unit charging cable thus simultaneously charging multiple food storage and warmer apparatuses.

6. The food storage and warmer apparatus of claim 5 further comprising the plurality of charge cables being a set of three charge cables.

7. The food storage and warmer apparatus of claim 1 further comprising the divider wall being T-shaped and the plurality of compartments comprising a first small compartment, a second small compartment, and a large compartment.

8. The food storage and warmer apparatus of claim 7 further comprising the first small compartment, the second small compartment, and the large compartment occupying 25%, 25%, and 50% of the housing inside, respectively.

9. The food storage and warmer apparatus of claim 1 further comprising the housing having rounded edges.

10. A food storage and warmer apparatus comprising:
a housing having a front side, a back side, a left side, a right side, a bottom side, and an open top side defining a housing inside, the housing having an outer wall separated from an inner wall defining a wall cavity, the housing having rounded edges;
a divider wall coupled to the housing within the housing inside, the divider wall defining a plurality of compartments, the divider wall being T-shaped and the plurality of compartments comprising a first small compartment, a second small compartment, and a large compartment;
a lid coupled to the housing, the lid being selectively engageable with the open top side to seal and alternatively expose the housing inside;
a heating coil coupled to the housing, the heating coil being coupled within the wall cavity of the bottom side;
a battery coupled to the housing, the battery being coupled within the wall cavity and being in operational communication with the heating coil, the battery having a charging port extending through the outer wall;
a control unit coupled to the housing, the control unit being coupled to the front side of the housing and being in operational communication with the heating coil and the battery, the control unit comprising a CPU, a plurality of control buttons, an integrated timer, and a display screen, the plurality of control buttons being used to set the timer and the desired temperature of the housing inside;
a temperature probe coupled to the housing, the temperature probe being coupled within the wall cavity and extending through the inner wall to the housing inside, the temperature probe being in operational communication with the control unit;
a plurality of indicator lights coupled to the front side of the housing, the plurality of indicator lights being in operational communication with the control unit and the battery, the plurality of indicator lights including a power status light and a battery charge level indicator; and
a multi-unit charging cable having a wall plug, a power adaptor splitter in operational communication with the wall plug, and a plurality of charge cables in operational communication with the power adaptor splitter, each charge cable being selectively engageable with the charging port, the multi-unit charging cable thus simultaneously charging multiple food storage and warmer apparatuses.

11. The food storage and warmer apparatus of claim 10 further comprising the first small compartment, the second small compartment, and the large compartment occupying 25%, 25%, and 50% of the housing inside, respectively.
